(19) United States
(12) Patent Application Publication
(10) Pub. No.: US 2026/0220758 A1
(43) Pub. Date: Jul. 30, 2026

(54) VEHICLE INSPECTION SYSTEM

(71) Applicant: DEGOULD LIMITED, Exeter, Devon (GB)

(72) Inventors: Daniel George GOULD, Exeter, Devon (GB); Mathew HOLLOWAY, Exeter, Devon (GB)

(21) Appl. No.: 19/145,668

(22) PCT Filed: Dec. 28, 2023
(86) PCT No.: PCT/GB2023/053380

§ 371 Date: Jul. 3, 2025

(30) Foreign Application Priority Data
Jan. 5, 2023 (GB) 2300145.6

(51) Int. Cl. G06T 7/00; G06T 19/00

(52) U.S. Cl. CPC G06T 7/0004; G06T 19/006; G06T 2207/20081; G06T 2207/20084; G06T 2207/20092; G06T 2207/30156

(57) ABSTRACT

A computer implemented method of vehicle inspection, the method comprising: processing one or more images of a vehicle using a defect detection algorithm to identify a defect on the vehicle; and generating an identifier on a display of an immersive display device when the vehicle and the defect are present in the field of view of the immersive display device, the identifier being displayed adjacent to the defect.

### CROSS-REFERENCE TO RELATED APPLICATIONS

This application is a national stage filing of International Application No. PCT/GB2023/053380 filed on Dec. 28, 2023 (corresponding to International Publication No. WO 2024/147006) which in turn claims priority to GB 2300145.6 filed on Jan. 5, 2023. The entire contents of both of these applications are hereby incorporated by reference herein.

### FIELD

This disclosure relates to the field of vehicle inspection systems.

### BACKGROUND

There are various situations in which a person is tasked with inspecting a vehicle for defects such as scratches, scuffs, chips, dents, dings, distortions, gap, flush and the like. Furthermore, the inspections may involve reviewing the spec of the vehicle as built against the spec required by the customer to identify any deviations between the two. Examples include quality control stages during vehicle manufacture, stages along a vehicle delivery process and pick up and return stages of a hire vehicle.

When a defect or deviation is identified, it needs to be graded, and if outside the allowable standard, repaired. This involves accurately locating the defect, measuring its size or impact, and then passing on clear instructions to the team responsible for resolving the issue.

It is known to provide a camera-based imaging system to capture images of a vehicle to be inspected. Such systems can capture images of a vehicle and a defect detection algorithm can identify suspected defects based on the images. A report can be generated which shows the vehicle and suspected defects for an inspector to use as a guide to check the vehicle.

However, due to the potential small size of a defect (e.g., less than 1 mm) and difficulty locating it on a large uniform painted surface (typically >30 million mm² painted surface area), it can be very time consuming to locate a defect even when given its location on the vehicle. For example, on a product line an inspector may locate a defect and mark it on the plant quality management system, the repair team are then shown its approximate location on a butterfly diagram and need to repair it. With the average time at each station of 60-80 seconds, even short delays in locating the defect can significantly impact the ability to repair the issue without stopping the line.

The present inventor has recognized that known vehicle inspection systems can be improved.

### SUMMARY

In accordance with a first aspect, there is provided a computer implemented method of vehicle inspection, the method comprising:
processing one or more images of a vehicle using a defect detection algorithm to identify a defect on the vehicle; and
generating an identifier on a display of an immersive display device when the vehicle and the defect are present in the field of view of the immersive display device, the identifier being displayed adjacent to the defect.

Thus, the vehicle inspection method according to the first aspect augments the user's view of the vehicle with an identifier displayed on the screen of immersive display device. The identifier is provided adjacent to the defect so that the identifier guides a user of the immersive display device to the location of the defect or deviation on the vehicle. The method can therefore increase the speed and accuracy of a vehicle inspection and repair process.

The identifier can be shaped and located so as not to occlude the defect. As such, the identifier can be shaped to enable the user to see the defect on the screen while the identifier is present on the screen.

The identifier can comprise a bounding shape around the defect, the bounding shape being internally transparent so that the defect is visible to the user within the bounding shape. The bounding shape can be sized such that its width and height or diameter are greater than corresponding dimensions of the defect on the screen, so that the bounding box closely conforms to the size of the defect without occluding the user's view of the defect.

The identifier can be displayed so as to be static relative to the defect. Thus, even as the user moves relative to the vehicle, the identifier remains adjacent to the defect.

The defect detection algorithm can be configured to categorise the defect with a defect type label and the method can further comprise a step of displaying the defect type label on the screen. Thus, the method can intuitively inform a user as to the type of defect that the defect detection algorithm has identified as being present on the vehicle.

The label can be displayed on the screen at a location which does not occlude the defect and can be located adjacent to the identifier to enable a user to intuitively associate the label with the defect.

The method can comprise presenting the user with a user selectable feedback input to confirm whether the defect type label is correct. The input can for example comprise “correct” and “incorrect” buttons which a user may select my way of a hand gesture, such as pressing a part of the screen corresponding to one of the buttons in the case of a phone or tablet or moving their hand in free space to be detected by a hand tracking system in the case of a headset.

The method can comprise, in response to the user selecting the feedback input, providing a positive reinforcement or negative reinforcement to train the defect detection algorithm. This may include confirming or rejecting a defect, selecting the right label, or adding a defect that the defect detection algorithm has missed. Once the defects are located and confirmed, any vehicle images in which they appear can be labelled, by creating a bounding box in each frame, and passed to a training algorithm. In addition, if the immersive display device incorporates a camera, additional close-up images may be stored pre or post repair to be assessed later, or used to train the defect detection algorithms.

The method can include, in response to the user selecting the feedback input, the ability to grade the defect by size or severity. The defect detection algorithm may estimate the size based on the localization algorithm and its bounding box, or by comparing the defect to previously graded defects. This allows users to quickly confirm, change or reject the grading while simultaneously looking at the defect and user interface.

The step of processing images can comprise identifying a plurality of defects and the step of generating an identifier can comprise generating a corresponding plurality of identifiers, one for each defect identified. The plurality of identifiers can be displayed simultaneously for each defect that is displayed on the screen, in some embodiments until the user has selected the input to confirm whether the defect type is correct or can be generated one at a time to step the user through assessment of each defect in turn.

The immersive display device can comprise an augmented reality (AR), mixed reality (MR) or virtual reality (VR) display device.

The method can comprise a step of identifying the vehicle using the immersive display device, for example based on a QR code or vehicle identification number (VIN) on the vehicle. This can be used to cause the display of the correct identifier(s) for the vehicle.

In accordance with a second aspect, there is provided a vehicle inspection system comprising:
a controller configured to receive data identifying a defect on a vehicle and cause an identifier to be displayed on a screen of an immersive display device when the vehicle and the defect are present in the field of view of the immersive display device, the identifier being displayed adjacent to the defect on the screen.

In accordance with a third aspect, there is provided a vehicle inspection system comprising:
a vehicle imaging station configured to capture one or more images of a vehicle;
a controller configured to process the images using a defect detection algorithm to identify a defect on the vehicle; and
an immersive display device configured to generate an identifier on a display of the immersive display device when the vehicle and the defect are present in the field of view of the immersive display device, the identifier being displayed adjacent to the defect on the screen.

Optional features of the first aspect can be applied to the second and third aspects in an analogous manner.

In accordance with a fourth aspect, there is a provided a vehicle inspection system comprising:
two or more vehicle imaging stations configured to capture one or more images of a vehicle at different stages of the production process;
a controller configured to process the images using a defect detection algorithm to identify a defect on the vehicle;
a display device and interface to review and grade the defects; and,
and an immersive display device configured to show the condition of the vehicle at different stages of production.

In accordance with the fourth aspect the immersive display device may be configured to enable an operator to assess damage on the vehicle, assess whether it was repaired correctly, or compare whether the damage was present at different stages of the production process.

The method may comprise comparing defects on multiple vehicles at once, for example displaying defects on a 3D model of the vehicle, generating a heat map or videos showing trends over time across a batch of vehicles. By using an immersive display, the operator may visualize and assess damage far more easily, leading to the identification of the root cause and production problems more quickly than otherwise would be possible.

To generate an identifier on a display of the immersive display device when the vehicle and the defect are present in the field of view of the immersive display device, the identifier being displayed adjacent to the defect on the screen.

In any of the preceding embodiments, the word defect may be used to describe damage, marks or soiling on the vehicle, or alternatively a deviation from the required specification of the vehicle.

### BRIEF DESCRIPTION OF THE DRAWINGS

By way of example only, certain embodiments will now be described by reference to the accompanying drawings, in which:

FIG. 1 is a diagram of a vehicle inspection system according to one embodiment;

FIG. 2 is a diagram of a display of an immersive display device of the vehicle inspection system of FIG. 1;

FIG. 3 is a flow chart illustrating a computer implemented method of vehicle inspection according to an embodiment; and

FIG. 4 is a diagram illustrating AI training and deployment phases for the defect detection algorithm according to an embodiment.

### DETAILED DESCRIPTION

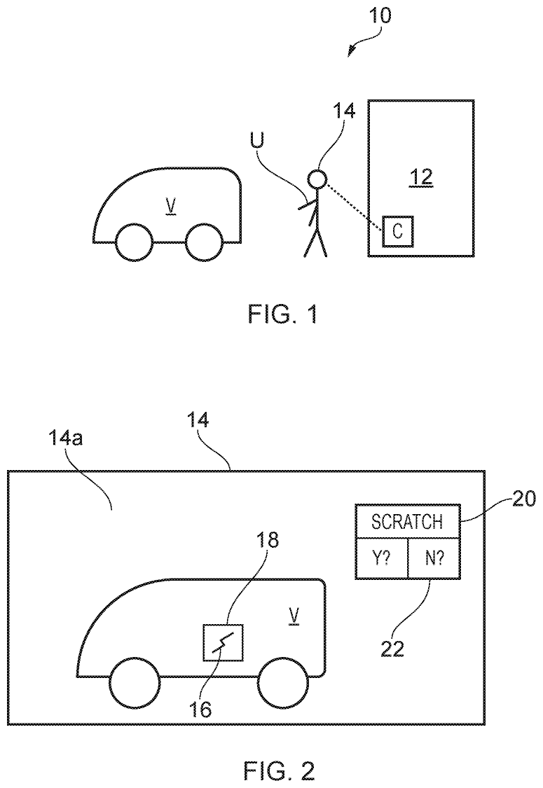

FIG. 1 shows a vehicle inspection system according to an embodiment generally at 10.

The system 10 includes an imaging station 12 for capturing images of a vehicle, a controller C for processing the images to identify one or more defects on the vehicle and an immersive display device 14. The system 10 can also include a database for storing information regarding the defects identified, such as the specific type of defect. The database can also include vehicle identification information such as a VIN.

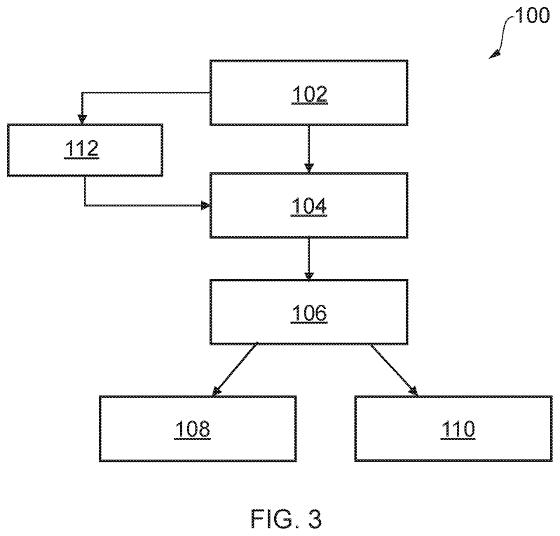

The imaging station 12 can take any suitable form that enables defects on the vehicle to be identified using images captured of the vehicle. The imaging station 12 can include one or more digital cameras and image acquisition software configured to capture one or more digital images of one or more portions of the vehicle V. The imaging station can for example comprise an imaging system as described with reference to FIG. 3 of WO2021/064351A1, having scratch detecting cameras arranged to view light and dark imaging background surfaces in reflection via the vehicle, and dent detecting cameras arranged to view a structured light image projected by a structure light source.

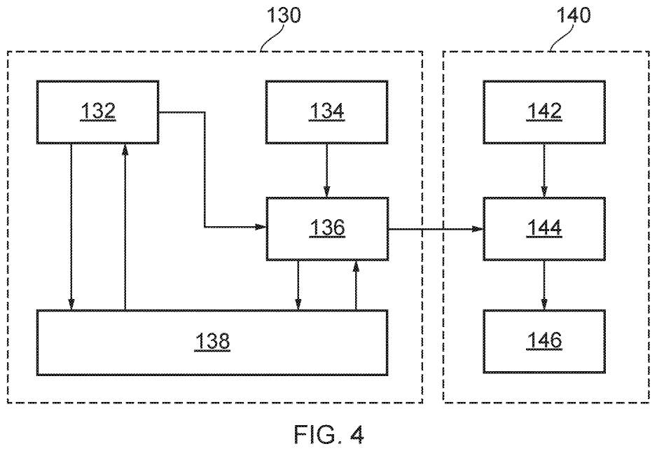

A controller C is communicatively coupled to the imaging station 12 over a data network and configured to receive the images captured by the imaging station 12 and execute a defect detection algorithm to identify vehicle defects using the assessment images. The defect detection algorithm is described in more detail with reference to FIG. 4.

Defect information such as defect type, size and location can be stored in a memory resource.

The controller C is also communicatively coupled to immersive display device 14, over the data network, such as over a wireless network.

The controller C is configured to use the defect information to cause the immersive display device 14 to display an identifier that guides the user U to the location of the defect on the vehicle V.

This can be achieved by, for example, aligning the defect information in the correct location on a digital twin of the vehicle V. The digital twin can be in the form of a virtual 3D model which can be pre-loaded on the immersive display 14. In this method, the immersive display device 14 is initialized with the virtual 3D model such that it can be used to match the location, rotation and scale of the virtual 3D model to the actual vehicle V. This match can be done using one or more Computer Vision techniques such as edge detection, feature matching, SLAM (Simulation Localization And Mapping). Alternatively, the matching can be done by utilising libraries designed for Augmented Reality (AR) that perform model tracking such as Vuforia, VisionLib, Wikitude and others.

Once the immersive display 14 has been initialized with the virtual 3D model such that a suitable match to the vehicle V has been acquired, the user U can move around the vehicle V using model tracking techniques without losing track of the virtual and real model of the vehicle V.

The defect information provided by the imaging station 12 and defect detection algorithm can then be used to produce overlays of the defects in the correct location using the 3D location (x,y,z) of the defects from the virtual 3D model in the reference frame of the virtual 3D model and be displayed in the correct location on the real vehicle V. As will be appreciated, the “correct location” is the location of the physical defect on the vehicle V.

The controller C can take any suitable form, such as general-purpose computing device and can comprise a distributed computing system.

The data network can comprise a high-speed data communication standard connection such as USB, IEEE 802 or IEEE 1394, including wired and/or wireless links.

The or each controller can be implemented as dedicated computer system having a computer processor and non-transitory computer readable memory for storing computer instructions for performing the functions described herein. The controller C can comprise one or more digital signal processors (DSP) for analysing large amounts of digital image data.

Referring additionally to FIGS. 2, the display screen 14a of the immersive display device 14 is shown viewing the vehicle V. A defect 16, which in this case is a scratch, is visible on the vehicle V. The identifier 18 is displayed on the display 14a and is sized and positioned to surround the defect in an adjacent manner without occluding the defect, so as to direct the user U to the defect.

The controller C can cause at least some of the damage information to be displayed to the user U on the immersive display device 14 as a defect identifier 20. For example, if the defect detection algorithm has identified a scratch on a door panel when processing the captured images, the screen of the immersive device 14 can include a text box that is visible to the user but does not occlude the defect on the vehicle V, informing the user U that the identifier is guiding them to what the algorithm has inferred to be a scratch.

The controller C can cause the immersive device 14 to display to the user U a user selectable feedback input 22 for the user to confirm whether there is a defect on the vehicle V which matches the damage information that has been displayed. The user can provide an input gesture to confirm whether the damage information is correct or incorrect. This feedback can be communicated to the controller C to train the defect detection algorithm by providing positive or negative reinforcement. For example, if the damage information displayed on the screen informs the user U that the defect is a scratch, but the user U considers the defect to be a dent, the user U can select a “N?” input to negatively reinforce the defect detection algorithm.

The controller C can communicate the feedback from the user U to the database of stored defects along with a label that the user U considers to be correct for the specific defect. The label can correspond to a type of defect. In keeping with the example above, the controller could communicate the “N?” input from the user U along with a label representative of the defect being a dent to the database.

Machine Learning (ML) algorithms then can retrain, for example offline, in dedicated computing systems with the updated information from the user U and automatically update the AI model used to produce detections. Once retraining is complete the new AI model can be used to produce more accurate results based on the user U feedback.

The controller C can be configured to vary the size of the defect identifier 20 based on how close the user is to the vehicle, providing a mixed reality (MR) experience. Likewise, the orientation and/or shape of the identifier 20 can be varied based on the position and viewing angle of the user U relative to the defect 16.

The immersive display device 14 can comprise a smartphone, tablet, smart lens, AR glasses or headset or MR glasses or headset. For example, a suitable immersive display device 14 is the Microsoft Hololens 2 or similar.

The system 10 can be configured to enable the vehicle V to be identified using the immersive display device 14, for example based on a QR code or VIN number on the vehicle. The vehicle identification information can be communicated to the controller C and used to recall the identifier(s) and damage information for the vehicle for display on the screen of the immersive device.

This can be achieved by communicatively coupling, via a network connection, the controller C to a database which comprises information for the vehicle V. Once the user U scans a QR code or enters a VIN number, the controller C can query the database for the identifiers(s) and damage information for the specific vehicle V. This can be facilitated by a network connection that can connect to the database and query using for example SQL queries for the required information.

Referring additionally to FIG. 3, a computer implemented method of vehicle inspection is shown generally at 100.

At step 102, the method comprises processing one or more images of a vehicle using a defect detection algorithm to identify a defect on the vehicle.

At step 104, the method comprises generating an identifier on a display of an immersive display device when the vehicle and the defect are present in the field of view of the immersive display device, the identifier being displayed adjacent to the defect.

The method can include the optional step 106 of presenting the user with a user selectable feedback input to confirm whether the defect type label is correct. The input can for example comprise “correct” and “incorrect” buttons which a user may select my way of a hand gesture, such as pressing a part of the screen corresponding to one of the buttons in the case of a phone or tablet or moving their hand in free space to be detected by a hand tracking system in the case of a headset.

The method can include the optional step 108 of, in response to the user selecting the feedback input, providing a positive reinforcement or negative reinforcement to train the defect detection algorithm. This may include confirming or rejecting a defect, selecting the right label, or adding a defect that the defect detection algorithm has missed. Once the defects are located and confirmed, any vehicle images in which they appear can be labelled, by creating a bounding box in each frame, and passed to a training algorithm. In addition, if the immersive display device incorporates a camera, additional close-up images may be stored pre or post repair to be assessed later, or used to train the defect detection algorithms.

The method can include the optional step 110 of, in response to the user selecting the feedback input, the ability to grade the defect by size or severity. The defect detection algorithm may estimate the size based on the localization algorithm and its bounding box, or by comparing the defect to previously graded defects. This allows users to quickly confirm, change or reject the grading while simultaneously looking at the defect and user interface.

The step 102 of processing images can optionally comprise identifying a plurality of defects and the step 104 of generating an identifier can optionally comprise generating a corresponding plurality of identifiers, one for each defect identified. The plurality of identifiers can be displayed simultaneously for each defect that is displayed on the screen, in some embodiments until the user has selected the input to confirm whether the defect type is correct or can be generated one at a time to step the user through assessment of each defect in turn.

The method can include the optional step 112 of identifying the vehicle using the immersive display device, for example based on a QR code or vehicle identification number (VIN) on the vehicle. This can be used to cause the display of the correct identifier(s) for the vehicle. This step 112 can be carried out at any point in the method, for example, as illustrated in FIG. 3, between steps 102 and 104.

Referring now to FIG. 4, a system diagram is shown illustrating an example AI training phase 130 and deployment phase 140 for systems according to embodiments.

The training phase 130 comprises a data and pre-processing module 132, an AI algorithm module 134, a training algorithm module 136 and an underlying architecture/platform on which the training phase 130 is carried out.

At the data and pre-processing module 132, training images of damaged vehicles are provided to illustrate what the system will be seeking to identify and quantify. For example, images which have visible and labelled scratches and/or dents are provided. For each type of damage, the severity can be labelled such that the AI can infer both a type of damage and its severity. The images may have a resolution such that one millimeter on a vehicle corresponds to approximately 4 or 5 pixels on the corresponding image of the vehicle and ideally 6 or more pixels per mm (equivalent to 25-40 pixels per millimeter squared). In one example implementation, this resolution is achieved using between 8 and 12 cameras that capture 61 megapixel images. Alternatively, the sensor resolution may be decreased but the number of cameras and frame rate increased to capture the required level of detail. The training data also includes labelling information corresponding to regions of the vehicles where an instance of damage is located. A labelled region associated with an image can correspond to a bounding box defining a region of the image containing damage. As such, the labelling information comprises, for a given image, a bounding box (e.g., relative x-y location of the top left corner of the region along with a width and/or height of the region) and a label corresponding to the class of damage contained within the region (e.g., scratch, dent, chip, etc.). Each image within the training data can be associated with more than one labelled region. In one example implementation, the training data comprises 500 manually annotated images of damaged vehicles, where each image contains one or more labelled regions associated with either a scratch class, dent class, or chip class.

The AI algorithm module 134 can comprise a known algorithm such as a convolution neural network (CNN), support vector machine (SVM) or the like.

The training algorithm module 136 applies the training data 132 to the AI algorithm 143. If the AI algorithm is CNN based or the like then the training algorithm can comprise back propagation with stochastic gradient decent. If the AI algorithm is SVM based then the training algorithm can comprise the use of known methods such as quadratic programming.

The AI training platform can comprise any suitable conventional computing device, for example comprising one or more GPUs, and can be implemented as a distributed network of commuting devices.

The deployment phase 140 forms an integral part of the vehicle imaging station 12 and comprises a new data module 142, a model module 144 and a predictions module 146.

The model module 144 comprise the trained algorithm that was output from the training algorithm module 136 and is executed on the controller C but can alternatively be executed by a data processor on a server for example.

The model module 144 receives as inputs the damage assessment images from new data module 142. Thus, the trained model is a program executable to identify vehicle defects using the captured images.

The model module 144 outputs predictions 146 comprising one or more of: instances and types of damage; severity of the damage; and location(s) of the damage.

In one example, a defect multi-task CNN assess the vehicle condition using machine learning datasets to provide a probability of damage, damage class and damage size. The multi-task CNN can operate locally on a data processor associated with the imaging station and/or in cloud-based computing, such as on the server. The multi-task CNN can continue to expand and learn using the images captured in the system. In one example, the trained neural network can be augmented using new data. Alternatively, the model can be updated by retraining the entire model, in some cases using the already trained model as a starting point i.e. rather than starting with a completely random configuration of network weights, the pre-trained weights are used as a starting point.

In one specific example implementation, AI algorithm module 134 implements a YOLO algorithm trained on a data set such as that described above in relation to the data and pre-processing module 132. The YOLO algorithm comprises a CSPDarknet53 backbone and a YOLOv5 object detector. The architecture is a convolutional base layer with a cross stage partial block which splits the feature map in the base layer and merges. The hyperparameters for the YOLO algorithm were determined using a standard grid search approach and the algorithm was trained using an Adam optimizer with ε=1e⁻⁷, β₁=0.9, and β₁=0.999.

Images can be uploaded into cloud storage, where they can be retrieved by the client from any location worldwide. Once all images are uploaded, they can be distributed to the AI via worker queues, which ensure services running the AI are processing the images in the order they are uploaded. The AI works directly on images of the vehicle. The machine learning models can be comprised of convolutional neural networks with YOLO object detection architecture and imagenet backbone are trained on hundreds of thousands of examples of previous vehicle defects, such that they are able to “learn” what constitutes a defect and what does not. The AI models can be deployed onto powerful cloud servers with cutting-edge GPU compute processing, which process the images and return detections as coordinate-based bounding boxes.

In other embodiments, the defect detection algorithm can have any suitable configuration that can identify a defect on the vehicle to enable the controller C to generate the identifier on the display of an immersive display device.

It should be noted that the above-mentioned embodiments and aspects illustrate rather than limit the invention, and that those skilled in the art will be capable of designing many alternative embodiments without departing from the scope of the invention as defined by the appended claims. In one example, embodiments of the invention extend to a vehicle inspection system comprising: two or more vehicle imaging stations configured to capture one or more images of a vehicle at different stages of the production process; a controller configured to process the images using a defect detection algorithm to identify a defect on the vehicle; a display device and interface to review and grade the defects; and, and an immersive display device configured to show the condition of the vehicle at different stages of production.

1. A computer implemented method of vehicle inspection, the method comprising:
processing one or more images of a vehicle using a defect detection algorithm to identify a defect on the vehicle; and
generating an identifier on a display of an immersive display device when the vehicle and the defect are present in the field of view of the immersive display device, the identifier being displayed adjacent to the defect, wherein the identifier is shaped and located so as not to occlude the defect and wherein the identifier corresponds to the defect identified.

2. (canceled)

3. The method of claim 1, wherein the identifier comprises a bounding shape around the defect, the bounding shape being internally transparent so that the defect is visible to the user within the bounding shape.

4. The method of claim 1, wherein the identifier is displayed so as to be static relative to the defect.

5. The method of claim 1, wherein the defect detection algorithm is configured to categorise the defect with a defect type label and the method further comprises a step of displaying the defect type label on the screen.

6. The method of claim 5, wherein the label is displayed on the screen at a location which does not occlude the defect and optionally is located adjacent to the identifier to enable a user to intuitively associate the label with the defect.

7. The method of claim 5, further comprising presenting the user with a user selectable feedback input to confirm whether the defect type label is correct.

8. The method of claim 7, further comprising, in response to the user selecting the feedback input, providing a positive reinforcement or negative reinforcement to train the defect detection algorithm.

9. The method of claim 5, further comprising, in response to the user selecting the feedback input, providing a second feedback input providing the user with the ability to grade the defect by size or severity.

10. The method of claim 1, wherein the step of processing images can comprise identifying a plurality of defects and the step of generating an identifier can comprise generating a corresponding plurality of identifiers, one for each defect identified.

11. The method of claim 1, wherein the immersive display device comprises an augmented reality (AR), mixed reality (MR) or virtual reality (VR) display device.

12. The method of claim 1, further comprising a step of identifying the vehicle using the immersive display device.

13. A vehicle inspection system comprising:
a controller configured to receive data identifying a defect on a vehicle and cause an identifier to be displayed on a screen of an immersive display device when the vehicle and the defect are present in the field of view of the immersive display device, the identifier being displayed adjacent to the defect on the screen, wherein the identifier is shaped and located so as not to occlude the defect and wherein the identifier corresponds to the defect identified.

14. A vehicle inspection system comprising:
a vehicle imaging station configured to capture one or more images of a vehicle;
a controller configured to process the images using a defect detection algorithm to identify a defect on the vehicle; and
an immersive display device configured to generate an identifier on a display of the immersive display device when the vehicle and the defect are present in the field of view of the immersive display device, the identifier being displayed adjacent to the defect on the screen, wherein the identifier is shaped and located so as not to occlude the defect and wherein the identifier corresponds to the defect identified.

15. A vehicle inspection system comprising:
two or more vehicle imaging stations configured to capture one or more images of a vehicle at different stages of the production process;
a controller configured to process the images using a defect detection algorithm to identify a defect on the vehicle;
a display device and interface to review and grade the defects; and
an immersive display device configured to show the condition of the vehicle at different stages of production and further configured to generate an identifier on a display of the immersive display device when the vehicle and the defect are present in the field of view of the immersive display device, the identifier being displayed adjacent to the defect on the screen and wherein the identifier is shaped and located so as not to occlude the defect and wherein the identifier corresponds to the defect identified.
